(19) United States
(12) Patent Application Publication
(10) Pub. No.: US 2009/0281798 A1
(43) Pub. Date: Nov. 12, 2009

(54) PREDICTIVE ENCODING OF A MULTI CHANNEL SIGNAL

(75) Inventors: Albertus Cornelis Den Brinker, Eindhoven (NL); Arijit Biswas, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,004

(22) PCT Filed: May 9, 2006
(86) PCT No.: PCT/IB2006/051445

§ 371 Date: Nov. 20, 2007

(30) Foreign Application Priority Data
May 25, 2005 (EP) 05104475.8

(51) Int. Cl. G10L 19/04

(52) U.S. Cl. 704/219; 704/E19.005

(57) ABSTRACT

A multi channel encoder (100) comprises a multi channel linear predictive analyzer (105) for linear predictive coding of a multi channel signal. A prediction controller (101) comprises a prediction parameter generator (301) which generates linear prediction coding parameter matrices for the multi channel signal which are then mapped to reflection matrices. The reflection matrices may specifically be normalized backward or forward reflection matrices. The reflection matrices are encoded by a reflection parameter encoder (305) and combined with other encoded data in a multiplexer (109) to generate encoded data for the multi channel signal. The reflection parameter encoder (305) may specifically decompose the reflection matrices using an Eigenvalue decomposition or a singular value decomposition and the resulting data may be quantized for transmission. A decoder (200) receives the encoded data and obtains the prediction parameters by performing the inverse operation.

The invention relates to encoding and/or decoding of a multi channel signal and in particular to encoding using linear predictive encoding.

Digital encoding of various source signals has become increasingly important over the last decades as digital signal representation and communication increasingly has replaced analogue representation and communication. For example, mobile telephone systems, such as the Global System for Mobile communication, are based on digital speech encoding. Also distribution of media content, such as video and music, is increasingly based on digital content encoding.

In content encoding, and in particular in audio and speech coding, linear predictive coding is an often employed tool as it provides high quality for low data rates. Linear predictive coding has in the past mainly been applied to individual signal but is also applicable to multi channel signals such as for example stereo audio signals.

Single channel linear prediction coding achieves effective data rates by reducing the redundancies in the signal and capturing these in prediction parameters. The prediction parameters are included in the encoded signal and the redundancies are restored in the decoder by a linear prediction synthesis filter.

An important parameter for the performance of linear predictive coding/encoding systems is the accuracy of the communicated prediction parameters. In particular, in order to achieve an effective data rate for a given quality level, the prediction parameters must be efficiently coded which generally includes a quantization of the parameters. However, the performance of the system is highly sensitive to this encoding and quantization.

Several methods for quantization and transmission of the prediction parameters for a single channel signal are known. The prediction parameters are not quantized individually because quantization errors of the individual coefficients of a linear prediction filter may substantially change the response of the filter and even minor quantization errors may even result in an unstable synthesis filter. Hence, such parameter quantization may significantly impact the encoding quality and provides little control over the frequency response of the associated prediction filter.

Instead, the prediction parameters for single channel signals are typically mapped to reflection coefficients, the arcsine representation thereof, Log Area Ratios (LARs) or the Line Spectral Frequencies (LSFs) in order to maintain control of the transfer characteristics and/or to minimize the effects of the quantizer. Further details may for example be found in the textbook “Speech coding and synthesis”, B. Kleijn and K. K. Paliwal (Eds.), Elsevier, Amsterdam, 1995, Chapter 12, pages 442-450.

For multi channel signals, linear prediction may also be used for encoding and decoding. This results in a multi channel analysis and synthesis system defined by multi channel prediction parameters. Such multi channel signals appear for instance in stereo audio data and multi-channel audio data but may also be different lines of an image.

It is known that if the orders of the individual transfers of the analysis system are equal and if the optimization is performed using input data windowing, then the stability of the synthesis system can be guaranteed.

However, although it is known to generate prediction parameters for a multi channel signal, it is not known how these may be effectively encoded and transmitted.

Encoding, and in particular quantization of multi channel prediction parameters, is associated with a number of problems.

Specifically, similarly to the single channel case, direct quantization of the parameters allows little control over the transfer characteristics. For example, the determinant of a prediction matrix (which is an important matrix characteristic) could easily change drastically in such an approach.

Furthermore, the quantization strategies known for the single channel case, such as the arcsine or the LAR representation, relates to individual scalar values and cannot directly be applied to the prediction parameter matrices of a multi channel case.

Another problem is that for multi channel systems, the forward and backward prediction systems can not be directly constructed from each other without additional knowledge.

Thus, currently no efficient method is known for multi channel prediction matrix encoding and quantization. Hence, an improved approach for multi channel encoding/decoding would be advantageous and in particular an approach allowing increased flexibility, low complexity, facilitated implementation, efficient encoding/decoding of multi channel prediction parameters, reduced data rates, improved quality and/or improved performance would be advantageous.

Accordingly, the Invention seeks to preferably mitigate, alleviate or eliminate one or more of the above mentioned disadvantages singly or in any combination.

According to a first aspect of the invention, there is provided an encoder for encoding a multi channel signal comprising: means for determining linear prediction coding parameter matrices for the multi channel signal; means for generating reflection matrices from the linear prediction coding parameter matrices; encoding means for coding the reflection matrices to generate encoded reflection matrix data; and means for generating encoded data for the multi channel signal comprising the reflection matrix data.

The invention may allow improved encoding of a multi channel signal. An improved quality and/or efficient data rate of an encoding (and decoding) process may be achieved. An efficient transmission of an encoded signal with high quality to data rate ratio may be achieved.

In particular, an improved coding of prediction data may be achieved. Specifically, transmission of prediction data for a multi channel signal using encoded reflection matrices may allow a high performance encoding of the signal. Specifically, the coding may include quantization of the parameters and the impact of quantization errors may be mitigated and/or controlled by encoding of reflection matrices.

The reflection matrices may be forward and/or backward reflection matrices. The multi channel signal may for example be a stereo or surround sound audio signal or may for example be different lines of an image.

According to an optional feature of the invention, the reflection matrices are normalized reflection matrices.

This may allow improved performance and may specifically allow an encoding resulting in an improved encoding quality versus data rate ratio.

According to an optional feature of the invention, the normalized reflection matrices are either normalized forward reflection matrices or normalized backward reflection matrices and the encoded data further comprises correlation data linking parameters of the normalized forward reflection matrices and the normalized backward reflection matrices.

The correlation data linking parameters may for example be a covariance matrix associated with the normalized forward reflection matrices and the normalized backward reflection matrices. The correlation data linking parameters may enable the reconstruction of the forward and backward reflection matrices from the normalized reflection matrices.

This may allow improved performance and may specifically allow an encoding resulting in an improved encoding quality versus data rate ratio as only data for one of either the normalized forward reflection matrices or the normalized backward reflection matrices need to be included.

According to an optional feature of the invention, the encoding means comprises means for decomposition of the reflection matrices to generate decomposed reflection matrices and for coding the decomposed reflection matrices to generate the encoded reflection matrix data.

This feature may allow an improved encoding and/or a practical implementation. A more efficient encoding of prediction data may be achieved from the results of a matrix decomposition. In many cases, similar characteristics may be achieved for the decomposed matrix data as for conventional single channel prediction data and similar encoding and particular quantization techniques may be used. Hence, an improved backward compatibility may be achieved in many cases.

According to an optional feature of the invention, the encoding means is arranged to determine a characteristic polynomial from the decomposed reflection matrices and the coding of the decomposed reflection matrices comprises coding coefficients of the characteristic polynomial.

According to an optional feature of the invention, the decomposition is an Eigenvalue decomposition.

An Eigenvalue decomposition may provide particularly advantageous performance. For example, data may be generated which is particularly suitable for coding, and in particular quantization, thereby allowing high quality versus data rate performance. Alternatively or additionally, the feature may allow a practical implementation.

According to an optional feature of the invention, the encoded reflection matrix data comprises quantized data of at least one or more of the group of: Eigenvalue data and Eigenvector data.

Eigenvalues and Eigenvector data may provide particularly advantageous data for encoding of prediction data. The Eigenvector data may for example comprise an angle indication for the Eigenvector.

According to an optional feature of the invention, the encoding means is operable to modify a quantization characteristic in response to at least one Eigenvalue.

This may improve performance and may allow a dynamic optimization of the encoding for the current characteristics of the multi channel signal.

According to an optional feature of the invention, the decomposition is a Singular Value Decomposition (SVD).

A Singular Value Decomposition may provide particularly advantageous performance. For example, data may be generated which is particularly suitable for coding, and in particular quantization, thereby allowing high quality versus data rate performance. Alternatively or additionally, the feature may allow a practical implementation.

According to an optional feature of the invention, the encoded reflection matrix data comprises quantized data of at least a singular value.

Singular value data may provide particularly advantageous data for encoding of prediction data.

According to an optional feature of the invention, the encoding means is operable to modify a quantization characteristic in response to at least one singular value.

This may improve performance and may allow a dynamic optimization of the encoding for the current characteristics of the multi channel signal.

According to an optional feature of the invention, the encoding means comprises means for generating the encoded reflection matrix data by quantization of parameters of the decomposed reflection matrices.

An improved performance may be achieved and/or implementation may be facilitated. The quantization may comprise non-linear mappings and/or non-uniform quantization. Specifically, in many embodiments, the invention may allow quantization techniques similar to those applied for conventional single channel signals, such as Log Area Ratios (LARs) or Arcsine representation.

According to a second aspect of the invention, there is provided a decoder for decoding a multi channel signal comprising: means for receiving encoded data for the multi channel signal, the encoded data comprising encoded reflection matrix data for reflection matrices of the multi channel signal; means for determining reflection matrices by decoding the reflection matrix data; determining linear prediction coding parameter matrices for the multi channel signal from the reflection matrices; and means for generating the multi-channel signal by linear prediction decoding based on the linear prediction coding parameters.

The invention may allow improved decoding of a multi channel signal. An improved quality and/or efficient data rate of an encoding and decoding process may be achieved. An efficient transmission and receipt of an encoded signal with high quality to data rate ratio may be achieved.

According to a third aspect of the invention, there is provided a method of encoding a multi channel signal comprising: determining linear prediction coding parameter matrices for the multi channel signal; generating reflection matrices from the linear prediction coding parameter matrices; coding the reflection matrices to generate encoded reflection matrix data; and generating encoded data for the multi channel signal comprising the reflection matrix data.

According to a fourth aspect of the invention, there is provided a method of decoding a multi channel signal comprising: receiving encoded data for the multi channel signal, the encoded data comprising encoded reflection matrix data for reflection matrices of the multi channel signal; determining reflection matrices by decoding the reflection matrix data; determining linear prediction coding parameter matrices for the multi channel signal from the reflection matrices; and generating the multi-channel signal by a linear prediction decoding based on the linear prediction coding parameters.

According to a fifth aspect of the invention, there is provided an encoded multi channel signal comprising encoded reflection matrix data for reflection matrices associated with linear prediction coding parameter matrices of the multi channel signal According to a sixth aspect of the invention, there is provided a computer program product for executing the method(s) of encoding and/or decoding the multi channel signal.

According to a seventh aspect of the invention, there is provided a transmitter for transmitting a multi channel signal comprising: means for determining linear prediction coding parameter matrices for the multi channel signal; means for generating reflection matrices from the linear prediction coding parameter matrices; encoding means for coding the reflection matrices to generate encoded reflection matrix data; means for generating encoded data for the multi channel signal comprising the reflection matrix data; and means for transmitting the encoded data.

According to an eight aspect of the invention, there is provided a receiver for receiving a multi channel signal comprising: means for receiving encoded data for the multi channel signal, the encoded data comprising encoded reflection matrix data for reflection matrices of the multi channel signal; means for determining reflection matrices by decoding the reflection matrix data; means for determining linear prediction coding parameter matrices for the multi channel signal from the reflection matrices; and means for generating the multi-channel signal by a linear prediction decoding based on the linear prediction coding parameters.

According to a ninth aspect of the invention, there is provided a transmission system for transmitting a multi channel signal comprising: a transmitter comprising: means for determining linear prediction coding parameter matrices for the multi channel signal, means for generating reflection matrices from the linear prediction coding parameter matrices, encoding means for coding the reflection matrices to generate encoded reflection matrix data, means for generating encoded data for the multi channel signal comprising the reflection matrix data, and means for transmitting the encoded data; and a receiver for receiving a multi channel signal comprising: means for receiving the encoded data; means for determining reflection matrices by decoding the reflection matrix data; means for determining linear prediction coding parameter matrices for the multi channel signal from the reflection matrices; and means for generating the multi-channel signal by a linear prediction decoding based on the linear prediction coding parameters.

According to a tenth aspect of the invention, there is provided a method of transmitting a multi channel signal comprising: determining linear prediction coding parameter matrices for the multi channel signal; generating reflection matrices from the linear prediction coding parameter matrices; coding the reflection matrices to generate encoded reflection matrix data; generating encoded data for the multi channel signal comprising the reflection matrix data; and transmitting the encoded data.

According to an eleventh aspect of the invention, there is provided a method of receiving a multi channel signal comprising: receiving encoded data for the multi channel signal, the encoded data comprising encoded reflection matrix data for reflection matrices of the multi channel signal; determining reflection matrices by decoding the reflection matrix data; determining linear prediction coding parameter matrices for the multi channel signal from the reflection matrices; and generating the multi-channel signal by a linear prediction decoding based on the linear prediction coding parameters.

According to a twelfth aspect of the invention, there is provided a method of transmitting and receiving a multi channel signal comprising: determining linear prediction coding parameter matrices for the multi channel signal; generating reflection matrices from the linear prediction coding parameter matrices; coding the reflection matrices to generate encoded reflection matrix data; generating encoded data for the multi channel signal comprising the reflection matrix data; transmitting the encoded data; receiving the encoded data for the multi channel signal; determining reflection matrices by decoding the reflection matrix data; determining linear prediction coding parameter matrices for the multi channel signal from the reflection matrices; and generating the multi-channel signal by a linear prediction decoding based on the linear prediction coding parameters.

According to a thirteenth aspect of the invention, there is provided an audio recording device comprising an encoder as previously defined.

According to a fourteenth aspect of the invention, there is provided an audio playing device comprising a decoder as previously defined.

According to a fifteenth aspect of the invention, there is provided an encoded multi channel signal comprising encoded data for the multi channel signal, the encoded data comprising encoded reflection matrix data for reflection matrices of the multi channel signal, the reflection matrices corresponding to linear prediction coding parameter matrices for a linear prediction encoding based of the multi channel signal.

According to a sixteenth aspect of the invention, there is provided storage medium having stored thereon such a signal.

These and other aspects, features and advantages of the invention will be apparent from and elucidated with reference to the embodiment(s) described hereinafter.

Embodiments of the invention will be described, by way of example only, with reference to the drawings, in which

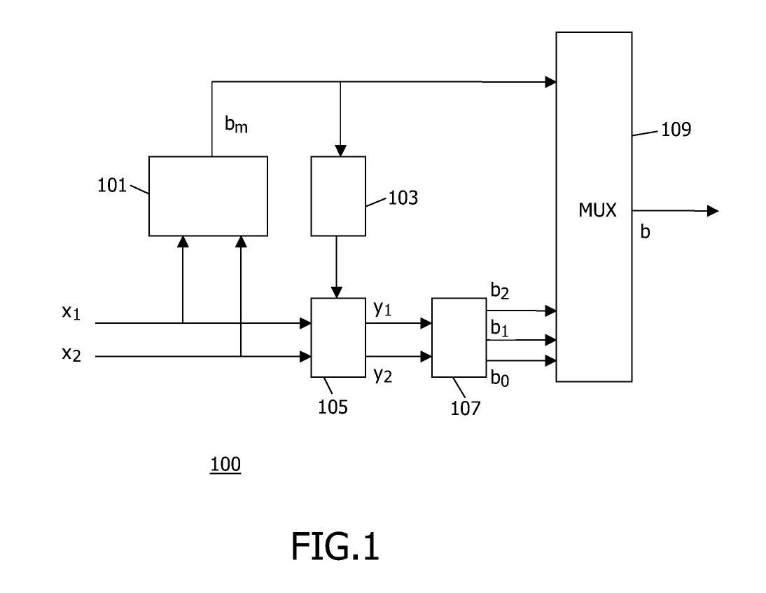

FIG. 1 illustrates an encoder for a stereo audio signal in accordance with some embodiments of the invention;

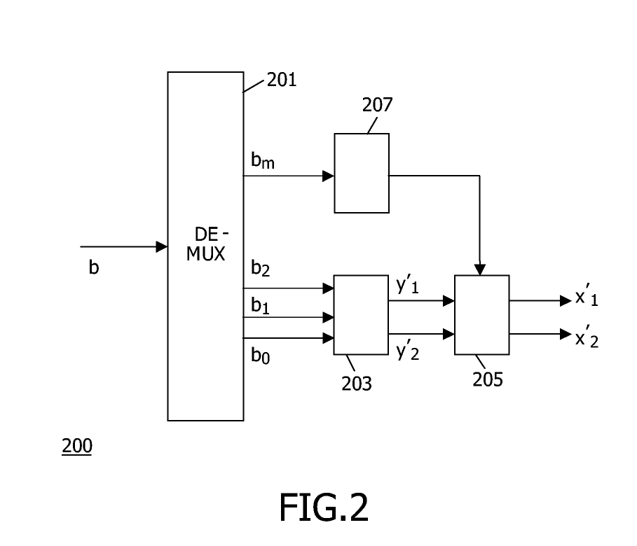

FIG. 2 illustrates a decoder for a stereo audio signal in accordance with some embodiments of the invention;

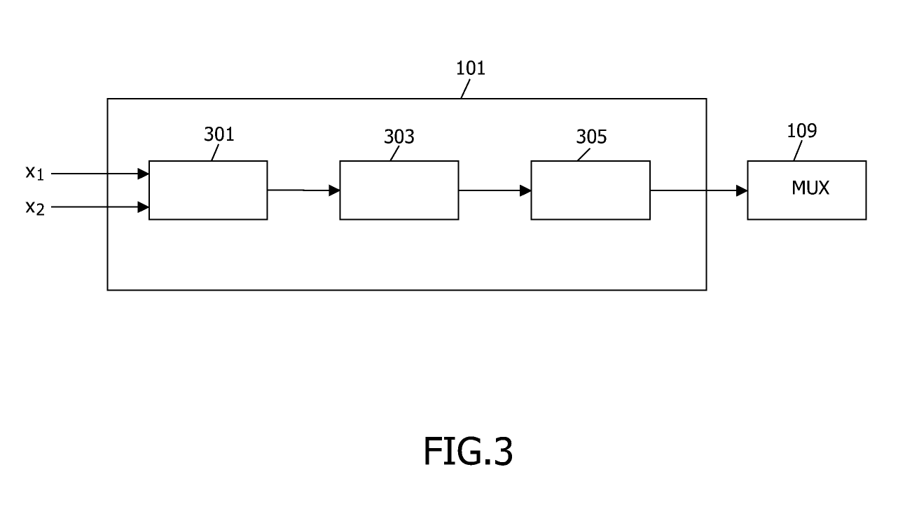

FIG. 3 illustrates elements of an encoder for a stereo audio signal in accordance with some embodiments of the invention;

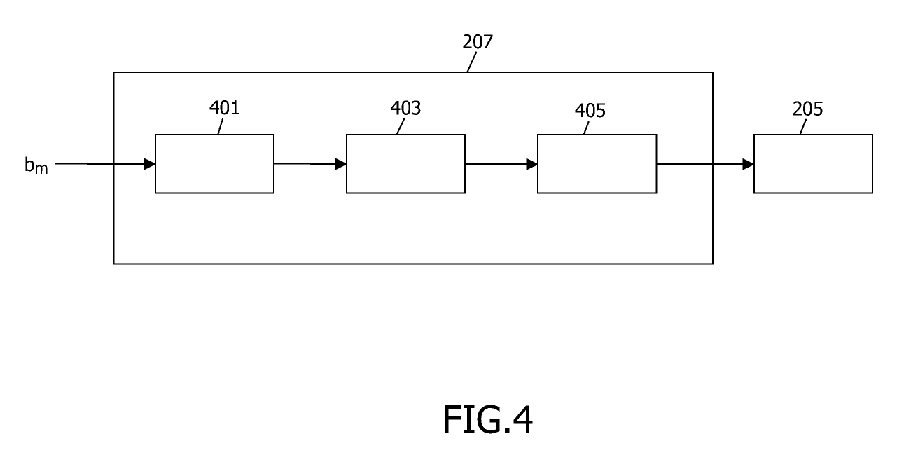

FIG. 4 illustrates elements of a decoder for a stereo audio signal in accordance with some embodiments of the invention;

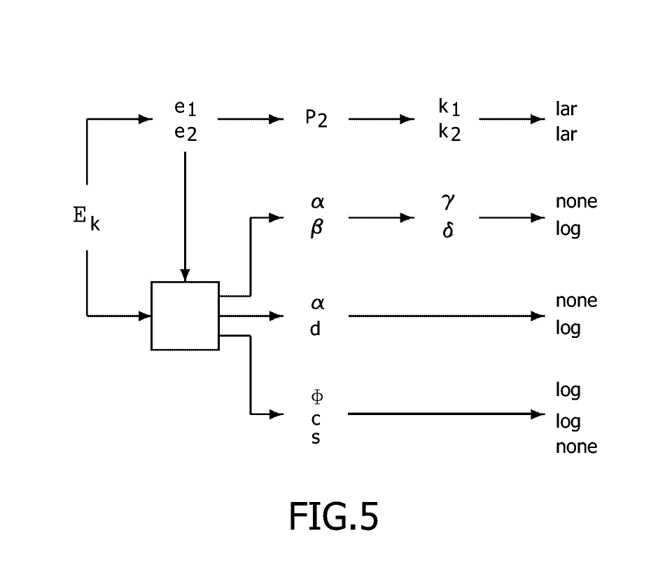

FIG. 5 illustrates a specific example of possible processing steps for an encoder in accordance with some embodiments of the invention;

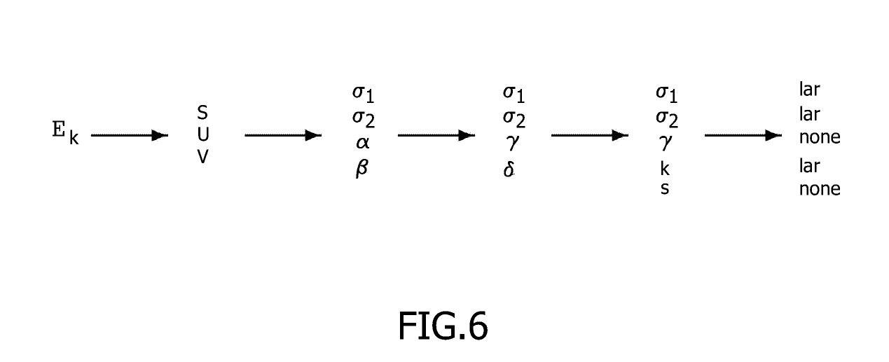

FIG. 6 illustrates a specific example of possible processing steps for an encoder in accordance with some embodiments of the invention;

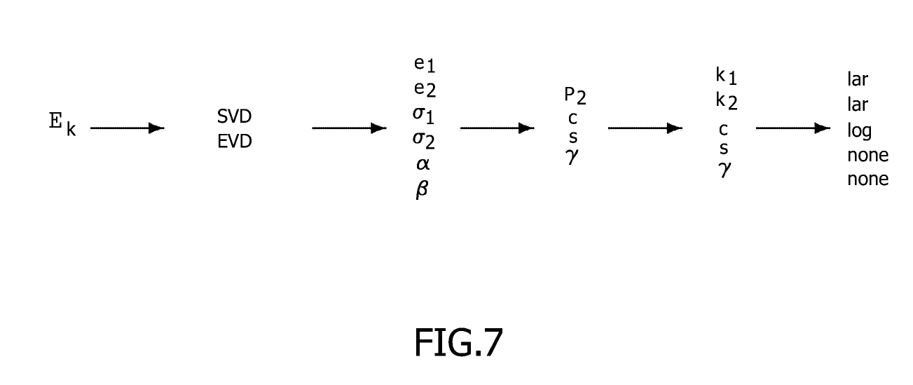

FIG. 7 illustrates a specific example of possible processing steps for an encoder in accordance with some embodiments of the invention; and

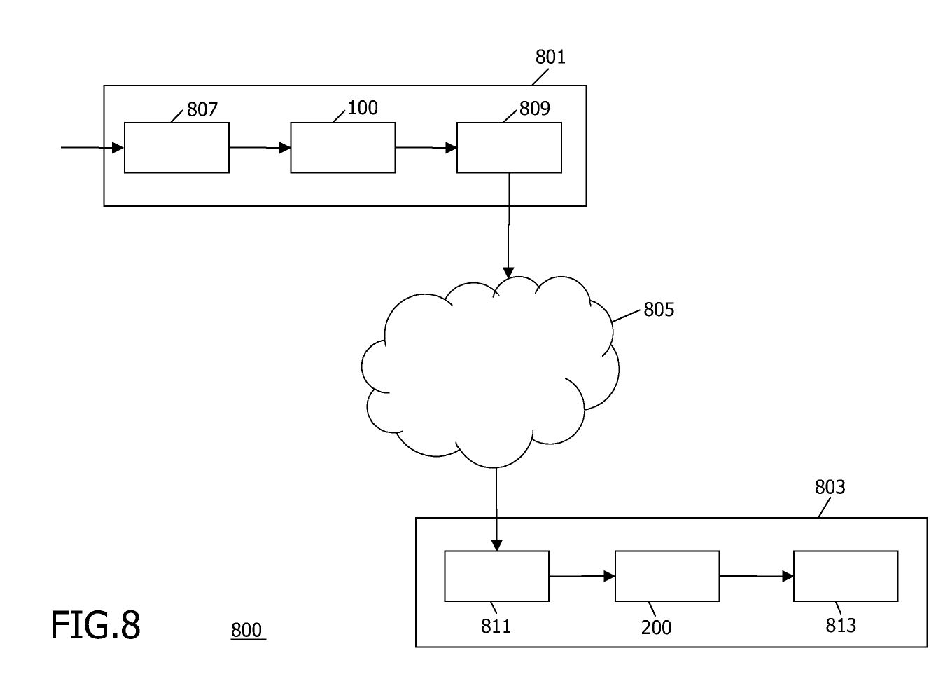

FIG. 8 illustrates a transmission system for communication of a multi channel signal in accordance with some embodiments of the invention.

The following description focuses on embodiments of the invention applicable to encoding and decoding of a stereo audio signal. However, it will be appreciated that the invention is not limited to this application but may be applied to many other multi channel signals.

FIG. 1 illustrates an encoder for a stereo audio signal in accordance with some embodiments of the invention. The encoder 100 receives a digitized (sampled) left and a right audio signal denoted by x₁ and x₂. For clarity and brevity, it is assumed that x₁ and x₂ comprise only real values but it will be appreciated that in some embodiments the values may be complex.

The encoder processes the sampled input signals x₁, x₂ in individual frames. Thus, the input signals x₁, x₂ are segmented into a number of sample blocks of a given size (e.g. corresponding to 20 msec intervals). The encoder then proceeds to generate prediction data and residual signals for each individual frame.

The stereo samples x₁, x₂ are fed to a prediction controller 101 which determines parameters for the predictions filters to be applied during the encoding and decoding process. The results of the analysis are encoded to generate the resulting data bₘ which is fed to a parameter decoder 103 which regenerates the prediction parameters from the encoded data bₘ. The parameter decoder 103 specifically applies the same algorithms and rules as will be applied in the decoder thereby ensuring that the prediction parameters used for encoding are substantially the same as the prediction parameters that will be used for decoding. In other words, any coding errors or inaccuracies introduced by the prediction controller 101 will equally affect the prediction filter of the encoder and the decoder.

The parameter decoder 103 is coupled to a linear predictive analyzer 105 which implements a linear predictive filter using the parameters determined by the parameter decoder 103. The linear predictive analyzer 105 furthermore receives the input signal samples x₁ and x₂ and determines error signals y₁ and y₂ between the predicted values and the actual input samples.

The error signals y₁ and y₂ are fed to a coding unit 107 which encodes and quantizes the signals y₁ and y₂ and generates corresponding bit streams b₁ and b₂. In addition the coding unit 107 may generate additional data b₀ indicative of various encoding or signal characteristics including for example a sample rate, a quantization characteristic, etc.

The coding unit 107 and the prediction controller 101 are coupled to a multiplexer 109 which combines the data generated by the encoder into a combined encoded signal b. In particular, the encoded data bₘ, b₀,b₁ and b₂ may be combined into a single bitstream.

Specifically, the linear predictive analyzer 105 may generate the error samples given by

$$\begin{matrix}{y}_{1} ( n ) = {x}_{1} ( n ) - {\sum }_{k = 1}^{N} {a}_{11 k} {x}_{1} ( n - k ) - {\sum }_{k = 1}^{N} {a}_{12 k} {x}_{2} ( n - k ) & ( 1 ) \\ {y}_{2} ( n ) = {x}_{2} ( n ) - {\sum }_{k = 1}^{N} {a}_{21 k} {x}_{1} ( n - k ) - {\sum }_{k = 1}^{N} {a}_{22 k} {x}_{2} ( n - k ) & ( 2 )\end{matrix}$$

where N is known as the prediction order (i.e. the number of past multi channel input samples taken into consideration for the prediction). The prediction matrices Aₖ (k=1, . . . , N) are given by

$${A}_{k} = ( \begin{matrix}{a}_{11 k} & {a}_{12 k} \\ {a}_{21 k} & {a}_{22 k}\end{matrix} ) . \qquad ( 3 )$$

In the z-domain this yields:

$$\begin{matrix}{Y}_{1} ( z ) = {X}_{1} ( z ) - {\sum }_{k = 1}^{N} {a}_{11 k} {z}^{- k} {X}_{1} ( z ) - {\sum }_{k = 1}^{N} {a}_{12 k} {z}^{- k} {X}_{2} ( z ) & ( 4 ) \\ {Y}_{2} ( z ) = {X}_{2} ( z ) - {\sum }_{k = 1}^{N} {a}_{21 k} {z}^{- k} {X}_{1} ( z ) - {\sum }_{k = 1}^{N} {a}_{22 k} {z}^{- k} {X}_{2} ( z ) & ( 5 )\end{matrix}$$

with X₁(z), X₂ (z), Y₁(z) and Y₂(z) being the z-transforms of x₁, x₂, y₁ and y₂, respectively.

It will be appreciated that alternative linear prediction systems can be achieved by changing the delay operators z⁻¹ of equations (4) and (5) by an all-pass filter Ã (z) with

$$\tilde{A} ( z ) = \frac{- λ + {z}^{- 1}}{1 - λ {z}^{- 1}} \qquad ( 6 )$$

with |λ|<1. This corresponds to a multi channel Warped Linear Prediction (WLP) system. Furthermore, Laguerre-based linear prediction systems can be mapped onto WLP systems. It will thus be clear that the proposed concepts and approaches can be applied equally to prediction matrices in such systems.

FIG. 2 illustrates a decoder 200 for a stereo audio signal in accordance with some embodiments of the invention.

The decoder 200 comprises a de-multiplexer 201 which receives the bitstream b from the decoder 100. The de-multiplexer 201 proceeds to separate the bitstream b into the different bit streams bₘ, b₀, b₁ and b₂.

The decoder 200 further comprises an inverse coding unit 203 which is fed the bitstreams b₀, b₁ and b₂. The inverse coding unit 203 proceeds to generate the error signals y′₁ and y′₂ which are reconstructions of y₁ and y₂, respectively.

The decoder 200 further comprises a prediction parameter processor 207 which is fed the bit stream bₘ and therefrom determines the prediction parameters. Specifically, the prediction parameter processor 207 preferably determines the filter coefficients of the linear prediction filter used to reconstruct the multi channel signal substantially identically to the approach used in the encoder 100.

The prediction parameter processor 207 and the inverse coding unit 203 are coupled to a linear predictive synthesizer 205. The linear predictive synthesizer 205 reconstructs the multi channel signal as x′₁ and x′₂ on the basis of the prediction parameters and the error signals y′₁ and y′₂.

In the example of FIGS. 1 and 2, the prediction parameters of the encoded signal is represented by encoded reflection matrix data for reflection matrices associated with linear prediction coding parameter matrices of the multi channel signal.

Specifically, the prediction controller 101 may determine the prediction matrices Aₖ and map these to reflection matrices. The reflection matrices may then be used for generating the encoded prediction data bₘ. Similarly, the prediction parameter processor 207 may determine the reflection matrices from the received bitstream bₘ and may then convert the reflection matrices to prediction matrices A′k. The reflection matrices are encoded by the prediction controller 101 and the use of reflection matrices allows a highly efficient encoding which may retain many of the advantageous parameter characteristics known from reflection coefficients of a single channel case.

FIG. 3 illustrates the prediction controller 101 of FIG. 1 in more detail. The prediction controller 101 comprises a prediction parameter generator 301 which generates linear prediction coding parameter matrices for the multi channel signal. Specifically, the prediction parameter generator 301 receives the stereo input samples x₁, x₂ and generates the prediction matrices Aₖ.

It will be appreciated that any suitable method for determining the prediction matrices Aₖ may be used without detracting from the invention. For example, the prediction matrices may be determined as the solution of a least-squares optimization problem involving normal equations. An efficient method of solving the normal equations in case of input data windowing (autocorrelation method) is given by the block-Levinson algorithm as disclosed in “Multichannel singular predictor polynomials”, P. Delsarte and Y. V. Genin, IEEE Trans. Circuits Systems, Vol. 35, 1988, pages 190-200.

The prediction parameter generator 301 is coupled to a reflection matrix generator 303 which generates reflection matrices from the linear prediction coding parameter matrices. If the block-Levinson algorithm is used, the prediction parameter generator 301 and the reflection matrix generator 303 are typically effectively combined into a single functional unit.

For a single channel signal, it is known to characterize a prediction filter used in linear predictive encoding by a number of reflection coefficients. In speech signals, the prediction filter is based on a physical model which emulates the vocal tract by tubes of different diameters. At each discontinuity, a reflection coefficient may indicate that a part of the signal is forwarded while another part is reflected.

For a single channel signal, a number of advantages may be achieved by using a reflection coefficient model. In particular, an efficient encoding of reflection coefficients can be achieved, for example by use of a non-linear mapping such as an arcsine or LAR (Log Area Ratio) representation.

However, for multi channel signals, no efficient way of coding (including quantizing) prediction parameters is known. The use of a simple model based on reflection coefficients is not feasible as the multi channel system cannot be accurately represented by simple coefficients. Furthermore, quantization of the prediction matrix values leads to significant distortions in the frequency domain even for minor quantization errors and may even result in non-stable synthesis filters.

In the encoder 100 of FIG. 1, the reflection matrix generator 303 generates a reflection matrix. Specifically, for a multi channel signal, a similar physical model may be used as for a single channel encoder but as the different signals may interact at the tube discontinuities, the reflection coefficients are replaced by reflection matrices.

Thus, the reflection coefficients of the single channel case are changed into reflection matrices. However, the fact that reflection coefficients have now become reflection matrices may result in the direct use of the quantization strategies for reflection coefficients to be inappropriate. In particular, direct use of the arcsine or the LAR representation may result in undesirable performance as the characteristics and performance sensitivities of the system are more sensitive to quantization errors of the matrix components than of the simple reflection coefficients.

In the encoder of FIG. 1, the reflection matrix generator 303 is coupled to a reflection parameter encoder 305 which codes the reflection matrices in order to generate encoded reflection matrix data thereby creating the bit stream bₘ. The reflection parameter encoder 305 is coupled to the multiplexer 109 which generates the encoded data b for the multi channel signal by multiplexing the bitstream bₘ with the bit streams b₀, b₁ and b₂ from the coding unit 107. Thus, in the encoded signal the prediction parameters used for encoding and decoding is represented by data indicative of the reflection matrix parameters.

In the embodiments of FIG. 1, the reflection matrices may be the directly generated forward and backward reflection matrices. Specifically, for multi channel systems, the forward and backward prediction systems can not be directly constructed from each other without additional knowledge. Accordingly, to allow the decoder to reconstruct the prediction parameters from the reflection matrices, both forward and backward reflection matrices may be transmitted.

However, in order to reduce the data rate and improve the coding efficiency, the forward and backward reflection matrices may be mapped onto normalized reflection matrices by e.g. the reflection matrix generator 303 or the reflection parameter encoder 305. In such embodiments, the reflection matrices encoded by the reflection parameter encoder 305 and included in the bit stream bₘ may be only one of the forward or backward reflection matrices. In addition, an additional covariance matrix may be determined which allows the forward reflection matrices to be determined from the backward reflection matrices or vice versa.

Specifically, with the information from this one additional covariance matrix, the normalized reflection matrices can be translated to both forward and backward reflection matrices.

The covariance matrix R₀ with entries r_{i,j}(i, j=1, 2) may be determined from the input signal by

$${r}_{i , j} = {\sum }_{n} {x}_{i} ( n ) {x}_{j} ( n ) .$$

The relation between forward/backward, matrices, normalized reflection matrices and the covariance matrix is described in “Multichannel singular predictor polynomials”, P. Delsarte and Y. V. Genin, IEEE Trans. Circuits Systems, Vol. 35, 1988, pages 190-200.

Hence, in the system of FIG. 1, the encoded signal comprises data of the prediction parameters, which are based on the reflection matrices. More particularly, it is suggested that normalized reflection matrices rather than the forward and backward reflection matrices are used together with the covariance matrix as this may reduce the data rate of the encoded signal.

More specifically, the prediction matrices Aₖ(k=1, . . . , N) may be mapped to forward and backward reflection matrices Γₖ and Γ′ₖ, respectively. This mapping is invertible but effectively results in a doubling of the number of matrices.

Preferably, the prediction matrices Aₖ are mapped to normalized forward and backward reflection matrices Eₖ and E′ₖ, respectively. The relation between Eₖ and E′ₖ is given by Eₖ^{t}=E′ₖ where ^{t} denotes transposition. Such a simple relation does not exist for the relation between Γₖ and Γₖ and specifically allows that a covariance matrix R₀ can be determined which can be applied to make the mapping {Aₖ}→{Eₖ} invertible. This matrix, R₀, contains the cross-correlation matrix of the input signal (or a scaled version thereof). Accordingly, using one of the normalized reflection matrices (either Eₖ or E′ₖ) plus R₀, N+1 matrices are generated which need to be transmitted rather than 2N as would be required for transmission of the forward and backward reflection matrices.

Furthermore, the normalized reflection matrices have advantageous properties. If the prediction parameters are derived using input data windowing (also known as the auto-correlation method) then the normalized reflection matrices are contracting matrices (the absolute value of Eigenvalues and singular values is less than 1) and, therefore, the associated linear prediction synthesis filter is guaranteed to be stable.

FIG. 4 illustrates the prediction parameter processor 207 of FIG. 2 in more detail. The prediction parameter processor 207 comprises a receive element 401 which receives the encoded reflection matrix data bₘ from the de-multiplexer 201. The receive element 401 is coupled to a reflection matrix regenerator 403 which determines the reflection matrices by decoding the reflection matrix data. For example, if the coding by the reflection parameter encoder 305 comprises a non-uniform quantization, the reflection matrix regenerator 403 applies the inverse non-uniform function to the received parameter values.

The reflection matrix regenerator 403 is furthermore coupled to a prediction parameter regenerator 405 which determines the linear prediction coding parameter matrices for the multi channel signal from the reflection matrices. Specifically, the prediction parameter regenerator 405 may generate the prediction parameters A′ₖ from the normalized reflection matrices (either Eₖ or E′ₖ) and the covariance matrix R₀.

The prediction parameter regenerator 405 is coupled to the linear predictive synthesizer 205 which is fed the regenerated prediction parameters A′ₖ. The linear predictive synthesizer 205 then proceeds to regenerate the multi channel signal by applying the prediction parameters A′ₖ in a multi channel linear prediction synthesis filter operating on the signals y′₁ and y′₂.

In some embodiments, the reflection matrices may be decomposed to generate decomposed reflection matrices and the encoded reflection matrix data may be generated by coding, and specifically quantizing, the parameters of the decomposed reflection matrices. Thus, specifically, the reflection parameter encoder 305 (or equivalently the reflection matrix generator 303) may specifically generate decomposed reflection matrices by decomposing the normalized forward and/or backward reflection matrices. Similarly, the reflection matrix regenerator 403 may generate the normalized forward and/or backward reflection matrices by performing the inverse operation of the decomposition.

In the examples, the reflection matrices are decomposed to result in structures that effectively maintain the major matrix characterizations. In particular, Eigen Value Decomposition (EVD) and/or Singular Value Decomposition (SVD) may be used.

An advantage of this approach is that the Eigenvalues and singular values have characteristics which are generally similar to many characteristics of reflection coefficients used for a single channel signal. In particular, the effect of quantization is comparable and therefore a quantization process very similar to that used for single channel reflection coefficients may be used by the reflection parameter encoder 305. Furthermore, the additional information resulting from these decompositions (specifically the Eigenvectors of the EVD and the unitary matrices of the SVD) can be quantized efficiently. Particularly advantageous performance may be achieved if the quantization accuracy is adapted in response to the Eigenvalues or singular values.

In the following a specific example will be described wherein Eigenvalue decomposition of reflection matrices is applied.

In the case of Eigenvalue decomposition, the following equation may be used:

Eₖ=WEW⁻¹, (7)

where W is a matrix (with suitably normalized) Eigenvectors and E is a diagonal matrix containing the Eigenvalues (e₁ and e₂) on its diagonal and assuming that the two Eigenvalues are not identical. The determinant of E is equal to the determinant Eₖ. The characteristics of the Eigenvalues are similar to that of reflection coefficients for a single channel signal. However, for a real matrix Eₖ, the Eigenvalues may be real or may appear as a complex-conjugated pair. In any case, the absolute value of the Eigenvalues is less than one.

In the case of real Eigenvalues, they can be treated in a similar way to reflection coefficients for a single channel signal and specifically a non-uniform quantization in the range (−1, 1) may be used (including a mapping to arcsine or LARs followed by a uniform quantization in these domains). For a complex Eigenvalue, different strategies can be used. For example, the radius may be obtained and mapped in a similar way to a real Eigenvalue and the angle of the complex number may be determined and quantized with an accuracy dependent on the radius. In this case, the bit stream b_{M} may comprise an indication of whether the values are real or complex numbers.

In other embodiments, the two Eigenvalues (either complex-conjugated or real) are used to generate a real second-order polynomial P₂, the so-called characteristic polynomial of the matrix Eₖ. The data of this second-order polynomial may then be transmitted by mapping it to reflection coefficients (and using arcsine or LAR representations) or mapping to LSFs followed by quantization.

For the Eigenvectors, two cases may further be distinguished. If the Eigenvalues are real and not identical, two real Eigenvectors are present in W which can be described by two angles:

$$W = ( \begin{matrix}cos ( α ) & cos ( β ) \\ sin ( α ) & sin ( β )\end{matrix} ) . \qquad ( 8 )$$

The advantage here over the SVD description is that each Eigenvalue is coupled to an Eigenvector so that the accuracy of the quantization of the angle can be directly determined from the associated Eigenvalue. Alternatively, the matrix W can be described as

W=W₁W₂ (9)

with W₁ an orthogonal matrix according to

$${W}_{1} = ( \begin{matrix}cos ( γ ) & - sin ( γ ) \\ sin ( γ ) & cos ( γ )\end{matrix} ) \qquad ( 10 )$$

and W₂ given by

$${W}_{2} = ( \begin{matrix}cos ( δ ) & cos ( δ ) \\ sin ( δ ) & - sin ( δ )\end{matrix} ) \qquad ( 11 )$$

where, without loss of generality, 0<|δ|<π/2. The relation between α, β and γ, δ is a transformation of coordinates. The angle γ is essentially halfway between α and β. Twice the angle δ is the difference between the angles α and β. Since variations in the parameter γ amount to a rotation of the entire system, this parameter can be quantized uniformly. All possible ill-conditioning of the matrix W resides in W₂ which has as determinant −sin(2δ). Therefore, quantizing δ can be done in such a way that the relative variation in the determinant is roughly constant.

In the case of a complex Eigenvalue, the complex Eigenvectors can be described by two angles as well, though the interpretation of these angles is obviously different than in the case of real Eigenvectors. For efficient data transmission, the accuracy of these angles is preferably coupled to the complex Eigenvalue, in particular to its radius. Alternatively, the matrix W can be described as

$$W = ( \begin{matrix}{r}_{1} {e}^{j φ} & {r}_{1} {e}^{- j φ} \\ {r}_{2} {e}^{- j φ} & {r}_{2} {e}^{j φ}\end{matrix} ) \qquad ( 12 )$$

i.e., by radii r₁, r₂ and one angle φ with 0<|φ|<π. Due to the fact that scaling of the Eigenvectors is allowed, this can be rewritten as

$$\begin{matrix}W = {W}_{3} {W}_{4} \\ with & ( 13 ) \\ {W}_{3} = ( \begin{matrix}sc & 0 \\ 0 & 1 / c\end{matrix} ) & ( 14 )\end{matrix}$$

with cεR⁺ and s=±1 and

$${W}_{4} = ( \begin{matrix}{e}^{j φ} & {e}^{- j φ} \\ {e}^{- j φ} & {e}^{j φ}\end{matrix} ) . \qquad ( 15 )$$

It should be noted that the determinant of W₃ equals ±1 and the determinant of W₄ equals 2j sin(2φ). The parameter c may be quantized uniformly on a log scale. The angle φ may be treated similarly as the parameters δ.

If the Eigenvalues are real and identical, the decomposition Eq. 7 does not hold. Instead, the following decomposition may be used:

$${E}_{k} = a [ I + d ( \begin{matrix}cos ( α ) \\ sin ( α )\end{matrix} ) ( \begin{matrix}- sin ( α ) & cos ( α )\end{matrix} ) ] \qquad ( 16 )$$

where e=e₁=e₂ is the Eigenvalue, I the identity matrix, α the angle associated with the Eigenvector and d a constant. The Eigenvalues can, as before, be mapped to a second-order polynomial (P₂), to reflection coefficients and quantized in the arcsine or LAR domain. The angle α can be efficiently quantized uniformly. The parameter d is a ratio indicating the weight of the matrix defined by α in comparison to the identity matrix I. The parameter d can be quantized in the log domain.

At the decoder, the received parameters of the Eigenvectors must be interpreted. This interpretation depends on the characteristics of the Eigenvalue as different parameters are present for the real and non-identical Eigenvalues, complex Eigenvalues, and identical Eigenvalues. Accordingly, the receiver must ensure that errors do not occur due to the Eigenvalues changing their character as a function of the applied quantization (for example by the imaginary value of a complex Eigenvalue being quantized to zero resulting in a real rather than complex quantized value).

Different strategies can be used to solve this. An option is to indicate the original character of the Eigenvalues in the bit stream. This indication may be used by the decoder to restore the nature of the Eigenvalue if it has been changed by the quantization. Another option is to control the Eigenvalue quantization in such a way that the character (real, complex, identical) of the quantized Eigenvalues remains unaltered. For example, the quantization of a complex value may not include the zero value. Yet another option is to check (in the encoder) if the character of the Eigenvalues has changed due to the quantization and choose appropriate parameters corresponding to the new character.

An example of the latter procedure is as follows. If in the quantization plane of the Eigenvalues, complex-conjugated pairs and real Eigenvalues are mapped onto the same representation (e.g., LAR), then presumably, there is also an Eigenvalue pair with e₁=e₂ which is mapped onto this representation. Roughly, for this quantization tile, the product e₁e₂ is substantially constant. The parameters γ, δ or φ, c may accordingly be omitted and replaced by the best parameters d, α. Since the quantization strategy is known at the decoder, the decoder knows for each quantized Eigenvalue pair whether the quantization strategy could have changed the Eigenvalue character. In that case the two Eigenvalues are taken as the geometric mean of the received Eigenvalues (i.e., real and identical) and the Eigenvector information is (correctly) interpreted as being d and α.

FIG. 5 illustrates a specific example of possible processing steps for an encoder in accordance with some embodiments of the invention. Obviously, many variations are possible, e.g., the LAR mappings may be replaced by arcsine mappings. The generation of the Eigenvector parameters from the input matrix is driven by the parameters e₁ and e₂ as discussed beforehand. As mentioned, possible confusion in the character (real/complex) of these values due to quantization is taken into account when generating the Eigenvector parameters. More elegantly, this may be done on basis of the character of the quantized Eigenvalues, since this is the information actually available at the decoder.

The decoder implements the inverse process. It receives the quantized parameters and reconstructs e₁ and e₂. Given these values, the receiver knows which Eigenvector data is contained in the bit stream: either γ, δ or s, c, φ or α, d. The matrix Eₖ can then be constructed.

In the following a specific example will be described wherein singular value decomposition of reflection matrices is applied.

In the case of singular value decomposition, the following equation may be used:

Eₖ=USV^{t}, (17)

where, commonly, U and V are unitary matrices and S is a diagonal matrix containing singular values:

$$S = ( \begin{matrix}{σ}_{1} & 0 \\ 0 & {σ}_{2}\end{matrix} ) \qquad ( 18 )$$

with σᵢ≧0. Given that Eₖ is a real matrix, all matrices U, S and V are real.

For convenience, a slightly different definition is used in the specific example described. In this example, the diagonal elements of S are not restricted to non-negative numbers but, instead, the unitary matrices U and V are restricted to rotation matrices. The diagonal elements of S are still referred to as the singular values.

For stable linear prediction synthesis filters, |σᵢ]<1.

The characteristics of the singular values are similar to those of the reflection coefficients and, therefore, they can be treated in a similar way to reflection coefficients for a single channel signal and specifically a non-uniform quantization in the range (−1, 1) may be used (including a mapping to arcsine or LARs followed by a uniform quantization in these domains).

As a specific example, the largest singular value may be quantized and transmitted in an arcsine, LAR, or LSF representation and the ratio r between the absolute values of the singular values (0≦r≦1) may be quantized and transmitted together with a sign parameter. Preferably, r is mapped onto a logarithmic scale and then uniformly quantized. In another alternative, when interpreting the two singular values as reflection coefficients, a second-order minimum-phase polynomial can be constructed which can be quantized and transmitted in standard ways (arcsine, LAR or LSFs).

The matrices U and V correspond to a rotation and, as such, each of these is coupled to a single parameter: the rotation angle. These angles are in a limited range [0, 2π) and can be quantized with an accuracy depending on the singular values. In the extreme case of the singular values being equal to zero, any angle would suffice, and therefore the required accuracy is none. In the case of large singular values (close to unity), a very fine resolution would be appropriate.

The accuracy of the quantization grid for the angles describing U and V can be based on different strategies. For example, the accuracy can be chosen on the basis of the maximum absolute singular value or the (arithmetic or geometric) mean of their absolute values. Alternatively, denoting U=R(α) and V^{T}=R(−β) with α and β the rotation angle, the following equation may be derived:

Eₖ=R(α)SR(−β)=R((α+β)/2)R((α+β)/2)SR(−(β−α)/2)R(−(β+α)/2) (19)

From this, it can be shown that the determinant of the system I−z⁻¹Eₖ does not depend on (α+β)/2. Therefore, the angle γ=(α+β)/2 can quantized with a uniform quantizer. The angle δ=(α−β)/2 is a factor in the determinant and can best be quantized in dependence on the singular values.

In particular, δ=(α−β)/2 may be quantized such that the characteristic equation associated with the matrix (and determining the Eigenvalues) remains unchanged. This can be done by introducing the reflection coefficient k with

$$k = - \frac{{σ}_{1} + {σ}_{2}}{1 + {σ}_{1} {σ}_{2}} cos ( 2 δ ) \qquad ( 20 )$$

The single channel methods for handling a reflection coefficient can be used, e.g., mapping to the LAR or arcsine domain. Preferably, G₁ and G₂ in the calculation of k are the quantized ones, since this relation has to be inverted in the decoder and, there, only the quantized singular values are available. The decoder mapping k→δ is ambiguous. To resolve the ambiguity, one extra bit s can be transmitted as well.

FIG. 6 illustrates a specific example of possible processing steps for an encoder in accordance with some embodiments of the invention. Obviously, many variations are possible, e.g., the LAR mappings may be replaced by arcsine mappings. As mentioned, the reflection coefficients k is a function of not only δ but of σ₁, σ₂ as well and, for inversion at the decoder, it may be advantageous to use the quantized values σ₁, σ₂ as these are available at the decoder.

The decoder implements the inverse process. It receives the quantized parameters and reconstructs σ₁ and σ₂. Given these values, the receiver is able to reconstruct δ from k and s. From γ and δ, the rotation matrices U and V can be reconstructed. Subsequently, the matrix Eₖ can be reconstructed.

In some embodiments, both Eigenvalue and singular value decomposition may be used together. Thus, the reflection matrices can be decomposed into both the Eigenvalue and singular value decompositions. Combining the Eigenvalues in a second-order polynomial (P₂) and quantizing the reflection coefficients (k₁ and k₂) belonging to this polynomial, gives an accurate control over the characteristic equation (as for the EVD method). The singular values can be mapped onto the ratio c=|σ₁/σ₂|. Such a ratio can be efficiently quantized uniformly on a log scale. The parameters α and β can be combined to γ=(α+β)/2 (like in the SVD method) and quantized uniformly.

FIG. 7 illustrates a specific example of possible processing steps for an encoder in accordance with some embodiments of the invention. Obviously, many variations are possible, e.g., the LAR mappings may be replaced by arcsine mappings.

The decoder implements the inverse process. It receives the quantized parameters and reconstructs e₁ and e₂. Given these values and c, the receiver is able to reconstruct S. From e₁, e₂, σ₁, σ₂ the parameter δ can be reconstructed. Similar to the SVD case, an ambiguity appears which may be resolved by an extra bit s. From δ and γ, the rotation matrices U and V can be constructed.

In all three examples (i.e. EVD, SVD and combined EVD/SVD), each (normalized) reflection matrix results in two coefficients (Eigenvalues in E or singular values in S) which, with some adaptation, can be treated like reflection coefficients in a single channel linear prediction system. The accompanying matrices (V and U, or W) may be encoded with an accuracy (number of bits) and/or an interpretation which may depend on characteristics of the Eigenvalues or singular values.

As mentioned earlier, the inverse mapping {Eₖ}→{Pₖ} requires an additional matrix R₀ which has the character of a covariance matrix (positive definite Hermitian matrix):

$${R}_{0} = ( \begin{matrix}{r}_{11} & {r}_{12} \\ {r}_{21} & {r}_{22}\end{matrix} ) \qquad ( 21 )$$

with r₁₂=r₂₁. This can be rewritten to

$${R}_{0} = \sqrt{{r}_{11} {r}_{12}} ( \begin{matrix}μ & ρ \\ ρ & {μ}^{- 1}\end{matrix} ) \qquad ( 22 )$$

with

$$μ = \sqrt{{r}_{11} / {r}_{22}}$$

and the correlation coefficient

$$ρ = {r}_{12} / \sqrt{{r}_{11} / {r}_{22}} .$$

The correlation coefficient is a value in between −1 and 1 and can be efficiently quantized on a non-uniform grid with less accuracy around the 0-value. The value μ can be effectively quantized on a dB scale. The value \sqrt{r₁₁r₂₂} in itself is of no interest for the mapping {Eₖ}→{Pₖ} and need not be transmitted.

Alternatively, the matrix R₀ may be decomposed by the earlier mentioned mechanisms (SVD or EVD) in which case only the ratio of the singular values (or Eigenvalues) and one angle needs to be transmitted (due to the specific structure of this matrix).

FIG. 8 illustrates a transmission system 800 for communication of a multi channel signal in accordance with some embodiments of the invention. The transmission system 800 comprises a transmitter 801 which is coupled to a receiver 803 through a network 805 which specifically may be the Internet.

In the specific example, the transmitter is a signal recording device and the receiver is a signal player device but it will be appreciated that in other embodiments a transmitter and receiver may used in other applications. For example, the transmitter and/or the receiver may be part of a transcoding functionality and may e.g. provide interfacing to other signal sources or destinations.

In the specific example where a signal recording function is supperted, the transmitter 801 comprises a digitizer 807 which receives an analog multi-channel signal which is converted to a digital PCM signal by sampling and analog to digital conversion.

The transmitter 801 is coupled to the encoder 100 of FIG. 1 which encodes the PCM signal as previously described. The encoder 100 is coupled to a network transmitter 809 which receives the encoded signal and interfaces to the Internet to transmit the encoded signal to the receiver 803 through the Internet 805.

The receiver 803 comprises a network receiver 811 which interfaces to the Internet 805 to receive the encoded signal from the transmitter 801.

The network receiver 811 is coupled to the decoder 200 of FIG. 2. The decoder 200 receives the encoded signal and decodes it as previously described.

In the specific example where a signal playing function is supported, the receiver 803 further comprises a signal player 813 which receives the decoded multi channel signal from the decoder 200 and presents this to the user. Specifically, the signal player 813 may comprise a digital to analog converter, amplifiers and speakers as required for outputting the multi-channel audio signal.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An encoder (100) for encoding a multi channel signal comprising:
means (301) for determining linear prediction coding parameter matrices for the multi channel signal;
means (303) for generating reflection matrices from the linear prediction coding parameter matrices;
encoding means (305) for coding the reflection matrices to generate encoded reflection matrix data; and
means (109) for generating encoded data for the multi channel signal comprising the reflection matrix data.

2. The encoder claimed in claim 1 wherein the reflection matrices are normalized reflection matrices.

3. The encoder claimed in claim 2 wherein the normalized reflection matrices are either normalized forward reflection matrices or normalized backward reflection matrices and the encoded data further comprises correlation data linking parameters of the normalized forward reflection matrices and the normalized backward reflection matrices.

4. The encoder of claim 1 wherein the encoding means (305) comprises means for decomposition of the reflection matrices to generate decomposed reflection matrices and for coding the decomposed reflection matrices to generate the encoded reflection matrix data.

5. The encoder of claim 4 wherein the encoding means (305) is arranged to determine a characteristic polynomial from the decomposed reflection matrices and wherein the coding of the decomposed reflection matrices comprises coding coefficients of the characteristic polynomial.

6. The encoder of claim 4 wherein the decomposition is an Eigenvalue decomposition.

7. The encoder of claim 6 wherein the encoded reflection matrix data comprises quantized data of at least one or more of the group of:
Eigenvalue data; and
Eigenvector data.

8. The encoder of claim 6 wherein the encoding means (305) is operable to modify a quantization characteristic in response to at least one Eigenvalue.

9. The encoder of claim 4 wherein the decomposition is a Singular Value Decomposition (SVD).

10. The encoder of claim 9 wherein the encoded reflection matrix data comprises quantized data of at least a singular value.

11. The encoder of claim 9 wherein the encoding means (305) is operable to modify a quantization characteristic in response to at least one singular value.

12. The encoder of claim 4 wherein the encoding means (305) comprises means for generating the encoded reflection matrix data by quantization of parameters of the decomposed reflection matrices.

13. A decoder for decoding a multi channel signal comprising:
means (401) for receiving encoded data for the multi channel signal, the encoded data comprising encoded reflection matrix data for reflection matrices of the multi channel signal;
means (403) for determining reflection matrices by decoding the reflection matrix data;
means (405) for determining linear prediction coding parameter matrices for the multi channel signal from the reflection matrices; and
means (205) for generating the multi-channel signal by a linear prediction decoding based on the linear prediction coding parameters.

14. A method of encoding a multi channel signal comprising:
determining linear prediction coding parameter matrices for the multi channel signal;
generating reflection matrices from the linear prediction coding parameter matrices;
coding the reflection matrices to generate encoded reflection matrix data; and
generating encoded data for the multi channel signal comprising the reflection matrix data.

15. A method of decoding a multi channel signal comprising:
receiving encoded data for the multi channel signal, the encoded data comprising encoded reflection matrix data for reflection matrices of the multi channel signal;
determining reflection matrices by decoding the reflection matrix data;
determining linear prediction coding parameter matrices for the multi channel signal from the reflection matrices; and
generating the multi-channel signal by a linear prediction decoding based on the linear prediction coding parameters.

16. An encoded multi channel signal comprising encoded reflection matrix data for reflection matrices associated with linear prediction coding parameter matrices of the multi channel signal.

17. A computer program product for executing the method of claim 14.

18-23. (canceled)

24. An audio recording device (801) comprising an encoder according to claim 1.

25. An audio playing device (803) comprising a decoder according to claim 13.

26. (canceled)

27. A storage medium having stored thereon a signal according to claim 26.
